(19) United States
(12) Patent Application Publication
(10) Pub. No.: US 2009/0001179 A1
(43) Pub. Date: Jan. 1, 2009

(54) Energy Efficient House Ventilation

(75) Inventor: Daniel J. Dempsey, Carmel, IN (US)

Correspondence Address: MARJAMA MULDOON BLASIAK & SULLIVAN LLP, 250 SOUTH CLINTON STREET, SUITE 300, SYRACUSE, NY, 13202, US

(73) Assignee: CARRIER CORPORATION, Farmington, CT (US)

(21) Appl. No.: 12/162,036

(22) PCT Filed: Feb. 14, 2006
(86) PCT No.: PCT/US2006/005154

§ 371 Date: Jul. 24, 2008

(51) Int. Cl. F24F 7/00; G05D 23/32; F24F 7/007; G05D 7/00

(52) U.S. Cl. 236/49.3; 236/49.5; 236/46 R; 454/333; 700/282

(57) ABSTRACT

A method and apparatus for maintaining an acceptable level of outside air exchange rate in a structure. The natural ventilation rate is determined as a function of the outdoor air temperature, and the amount of mechanically induced ventilation that is used to supplement the natural air ventilation is controlled such that the sum of the natural occurring ventilation and the mechanically induced ventilation is maintained by a substantially constant predetermined level. One approach is to use a stepper motor to modulate the position of the damper, while another approach is to use an on/off motor damper and to close the damper at outdoor temperatures below a threshold level and to otherwise leave the damper open and use the regular on/off cycle of the system blower to control the flow of outdoor air, with provision for allowing the fan to remain on for a calculated period of time after the system is cycled off to thereby maintain the desired level of ventilation. Can also vary the speed of the furnace blower or a separate ventilation fan motor.

### BACKGROUND OF THE INVENTION

This invention relates generally to comfort systems for houses and, more particularly to a method and apparatus for regulating the flow of outside air into a home to maintain the air quality therein.

The ASHRAE standard for acceptable ventilation and air quality in low rise residential buildings prescribes a fixed amount of outside ventilation air that must be provided to the home on a continuous, 24 hour per day, basis. In formulating the standard, they presumed that every house has an equivalent of a 0.15 air change rate per hour, and then requires mechanical ventilation air flow to achieve at least 0.35 air changes per hour, which is the level deemed “healthy” by most indoor air quality experts. The degree of mechanical ventilation air flow required is then a simple function of the size of the home and does not consider actual home infiltration rates.

The fact is that many homes are actually leakier than 0.15 air changes per hour, so that the prescribed ventilation air flow by ASHRAE will result in over ventilation of most homes. Though conservative, from a ventilation standpoint, too much ventilation air, particularly during periods of cold weather, can cause comfort problems for the occupants due to cold blow, durability problems for the HVAC equipment (too cold a return air temperature to the furnace causes condensation on the heat exchanger and vent surfaces that leads to corrosion failure), and unnecessary energy consumption to treat the cold outside air.

Further complicating the matter is the effect of the phenomenon known as the “stack effect,” wherein a natural increase in house infiltration air change rate occurs as the temperature differential between the indoors and outdoors increases. This effect, of course, is not fully considered in the fixed 0.15 ACH default level assumed by the ASHRAE standard, such that, as outdoor temperatures decrease, natural infiltration rates increase, and the over ventilation as caused by the ASHRAE standards, increases.

Various approaches have been taken to meet the ASHRAE standard. One is by ducting outside air to the return duct of the furnace air handler. When the furnace fan is on, the negative pressure in the return duct ingests outside air into the return duct system. Though very low in cost to apply, such a system provides little control over the amount of outside air being pulled into the return duct. Some degree of control is necessary in order to provide just enough air to meet the ASHRAE standard requirement. Uncontrolled outside air will cause cold blow and lead to furnace heat exchanger and vent corrosion, particularly during cold weather.

One approach to control the flow of outside air is that of requiring the installer to “dial in” the CFM level of outside air required, and an automated damper is then controlled by a kit logic center to maintain that CFM level whenever the fan is operating. Though this ensures that some control is maintained over the amount of ventilation airflow, there is no means in which to prevent over ventilation during periods of cold weather, nor to avoid the potential of cold blow and furnace heat exchanger and vent corrosion.

Another prior art system that is that of requiring field adjustment of the damper in order to provide the required ventilation rates. However, unlike the above mentioned apparatus, this is not an intelligent control and it is therefore not very precise, such that the amount of ventilation air ingested is highly variable. This approach may provide temperature and humidity sensing capabilities and may provide for closing the damper during very cold weather (0 deg F.) and whenever the humidity level in the return duct exceeds 60%. While this does provide some degree of control, it does not significantly impact energy costs, particularly during the heating season.

### SUMMARY OF THE INVENTION

Briefly, in accordance with one aspect of the invention, the degree of mechanical ventilation is reduced to compensate for an increase in the natural ventilation that occurs from the “stack effect”. In this manner, over ventilation during periods of hot or cold weather is minimized.

In accordance with another aspect of the invention, for any particular building, on any particular day, the pressure differential between the inside and outside of the structure can be calculated, and the infiltration flow rate due to stack effect can then be computed. Inherent change in infiltration rate can then be computed as a function of outdoor air temperature as indoor temperature is fairly constant. The amount of mechanical ventilation air flow is then varied in response to the outdoor temperature in order to maintain a constant air change rate as desired.

By another aspect of the invention, the control of the outside ventilation air flow is made by a two position open/closed damper, and the amount of run time of the HVAC system flow is varied in response to outdoor temperature variations to provide the required amount of outside air.

By yet another aspect of the invention, the control of the outside ventilation air flow is made by way of a damper which is modulated in steps in response to changes in outdoor temperature so as to thereby provide the desired amount of outside air for the HVAC system blower which operates continuously.

In the drawings as hereinafter described, a preferred embodiment and modified embodiments are depicted; however, various other modifications and alternate constructions can be made thereto without departing from the true spirit and scope of the invention.

### BRIEF DESCRIPTION OF THE DRAWINGS

FIG. 1 a schematic illustration of an installed furnace system with the present invention incorporated therein.

FIG. 2 is a prior art graphic illustration of both the percent hours of season operation and mixed air return temperature as a function of outdoor temperature.

FIG. 3 is a prior art graphic illustration of air change rate (ACH) as a function of outdoor air temperature with the 0.15 ACH default level assumed in the standard ASHRAE procedure.

FIG. 4 is a graphic illustration of infiltration rate as a function of outdoor temperature due to stack effect.

FIG. 5 is a graphic illustration of the air change rate as a function of outdoor temperature in accordance with the present invention.

FIG. 6 is a schematic illustration of a control assembly in accordance with one embodiment of the invention.

FIG. 7 is a graphic illustration of a thermostatic duty cycle versus outdoor temperature in accordance with the present invention.

FIG. 8 is a graphic illustration of the ventilation hours per day as a function of outdoor temperature in accordance with the present invention.

FIG. 9 is a graphic illustration of the fan added off time versus duty cycle in a heating mode in accordance with the present invention.

FIG. 10 is a graphic illustration of the fan off delay time versus duty cycle in the cooling mode in accordance with the present invention.

### DESCRIPTION OF THE PREFERRED EMBODIMENT

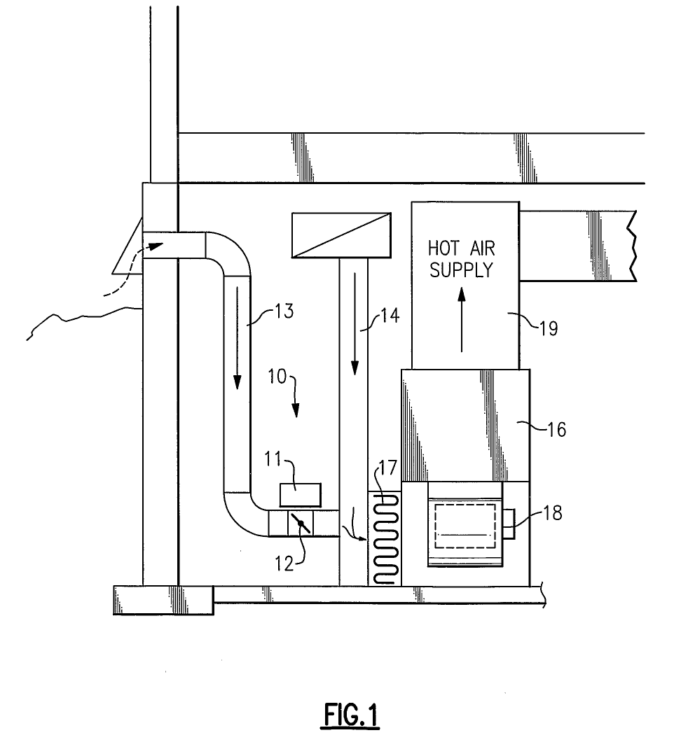

Referring now to FIG. 1, the invention is shown generally at 10 as applied to a damper control 11 which is operative to control the position of a damper 12 in a manner to be described more fully hereinafter.

The damper 12 is disposed within an outside air duct 13 for regulating the amount of outside air that passes through the outside air duct 13 to a return air duct 14. The return air duct 14 is installed in such a manner that it conducts the flow of relatively cool air from the space being heated back to a furnace 16 by way of an air filter 17. A blower 18 in the furnace 16 acts to draw into the furnace the return air from the return air duct 14, as well as outside air through the outside air duct 13 when the damper 12 is open. The air mixture is then heated by the furnace 16 and delivered to the spaced to be heated by way of the hot air duct 19.

It should be mentioned that the purpose of introducing the outside air into the system is to ensure that the quality of the air in the structure is maintained such that it does not become stagnant. The present invention accomplishes this in an efficient and effective manner. Generally, whenever the furnace blower 18 is on, the damper 12 would be opened by the furnace or thermostat control. When the blower 18 is off, the damper 12 would be either shut or at rest at a minimum open position.

Before discussing the details of the present invention, a discussion of the general operating characteristics and problems associated with use of outside air for ensuring air quality is appropriate.

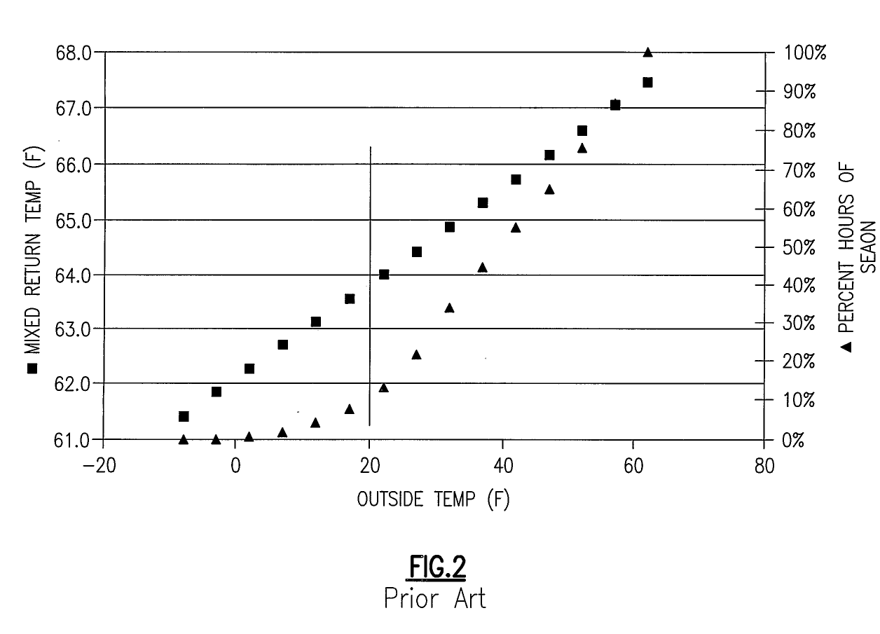

Shown in FIG. 2 is a mixed outside and return air temperature analysis of a furnace located in a typical (i.e. average) location for a gas furnace. In particular, attention should be given to periods in which the outside air temperature drops below 20° F. It will be seen that a percentage of hours at and below this condition becomes a very small part of the heating season (i.e. less than 10%). Also, at outside temperatures less than 20° F. the mixed air temperature (outside air plus return air) can continue to drop. The reduction in return air temperature to a gas furnace will correspondingly decrease the heated air temperature delivered to the house causing cold-blow comfort problems to the occupants. Colder return air can also increase the possibility of flue gas condensation in the heat exchanger or venting system, leading to premature corrosion failure.

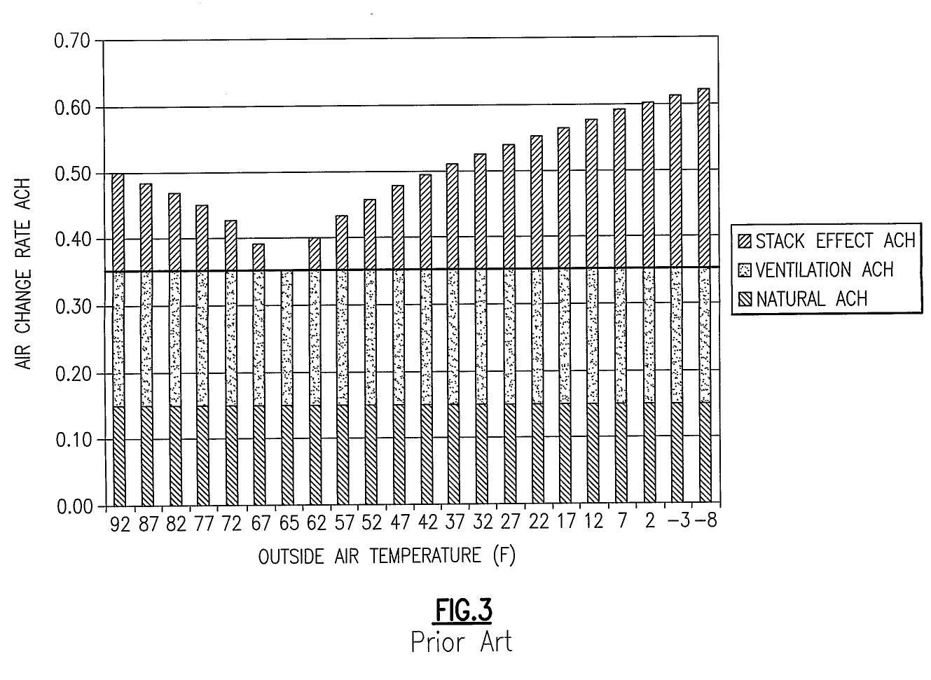

Considering now the manner in which the ASHRAE standards are presently being complied with, there is shown in FIG. 3 the way in which in the stack effect can lead to over ventilation of a building. Assuming the 0.15 ACH ASHRAE default natural infiltration rate, in order for the ASHRAE standard target of 0.35 ACH to be obtained, a mechanical infiltration rate of 0.20 ACH is provided. However, because of the stack effect, at temperatures both above and below 65° F., the natural infiltration caused by the stack effect causes the total ventilation to far exceed the standard of 0.35 ACH, especially at the lower temperatures.

The applicants have addressed this problem by computing the amount of infiltration that is caused by the house “stack effect”. Once this is known, the amount of mechanical ventilation air needed to maintain a minimum of 0.35 ach can be determined. The methodology then relates outdoor air temperature to HVAC system duty cycle, such that the amount of ventilation air required becomes a simple function of thermostat on/off duty cycle. In order to compute the stack effect of a particular building, it is first helpful to compute the pressure differential Pₛ between the inside and outside of a structure as caused by the stack effect. This can be calculated as follows:

Pₛ=0.52*P*H*(1/Tₒ−1/Tᵢ)
where P=ambient pressure, psia
H=building height, feet
Tₒ=Absolute outdoor temperature, degree R
Tᵢ=Absolute indoor temperature, degree R.

With the pressure differential known, the infiltration flow rate can be computed using the genetic relationship:

Flowrate=Cd*A*(2g*Ps*5.202/0.075)^{0.5}
where flow rate=infiltration rate, CFM
Cd=Flow coefficient constant
A=Leakage cross sectional area
g=gravitational constant
Ps=stack effect, in W.C.
5.2020=pressure units conversion.

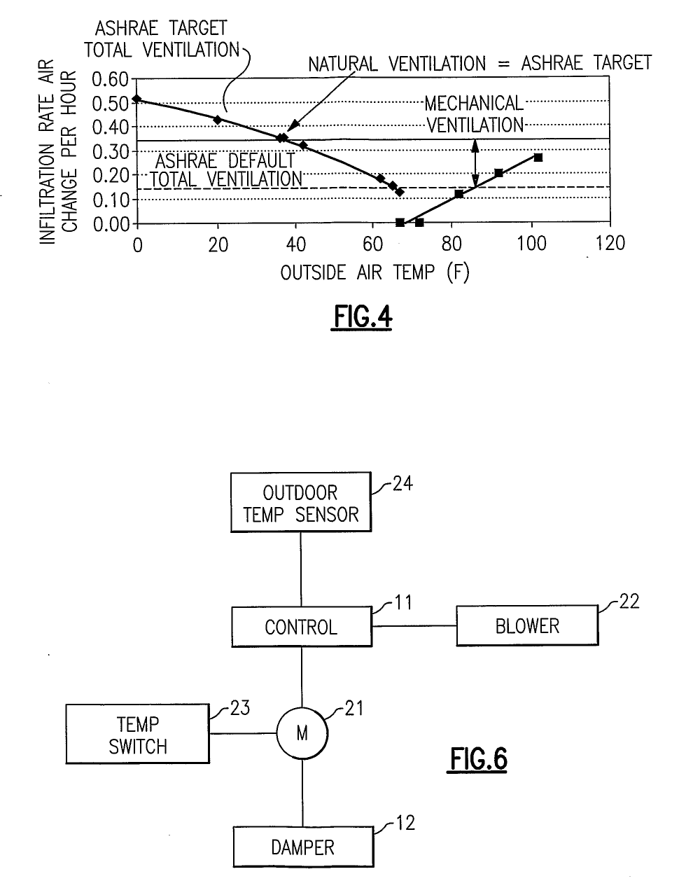

From these two equations, the inherent change in infiltration rate for a home can be computed as a function of outdoor air temperature as shown in FIG. 4 for a one story ranch. Note that neither the flow coefficient nor the leakage area is known, but since the ASHRAE standard just assumes that all homes have a natural infiltration rate equal to 0.15 air changes per hour, the relative flow rate as a function of temperature can be computed.

In the data represented in the curve on the left side of FIG. 4, it is assumed that the house in question has an infiltration rate of 0.15 ACH at approximately 62° F. outdoor temperature and 72° F. indoor temperature. For summer operation, the indoor temperature is assumed to be higher than during the winter, and explains why the summer time curve does not intersect the 0.15 ACH point until a 10° F. differential exists between indoors and outdoors (75° F. and 85° F., respectively). Since the infiltration rate of a home will increase naturally due to stack effect, the proposed concept is to reduce the amount of mechanical ventilation airflow with outdoor air temperature in order to maintain a constant air change rate of 0.35 ACH, which is the ultimate intent of the ASHRAE standard.

The benefit of this concept is that it minimizes energy cost to treat the outside ventilation air, and minimizes the ingestion of cold or hot/humid air that cause consumer discomfort, and it minimizes the potential for furnace heat exchanger and vent system corrosion.

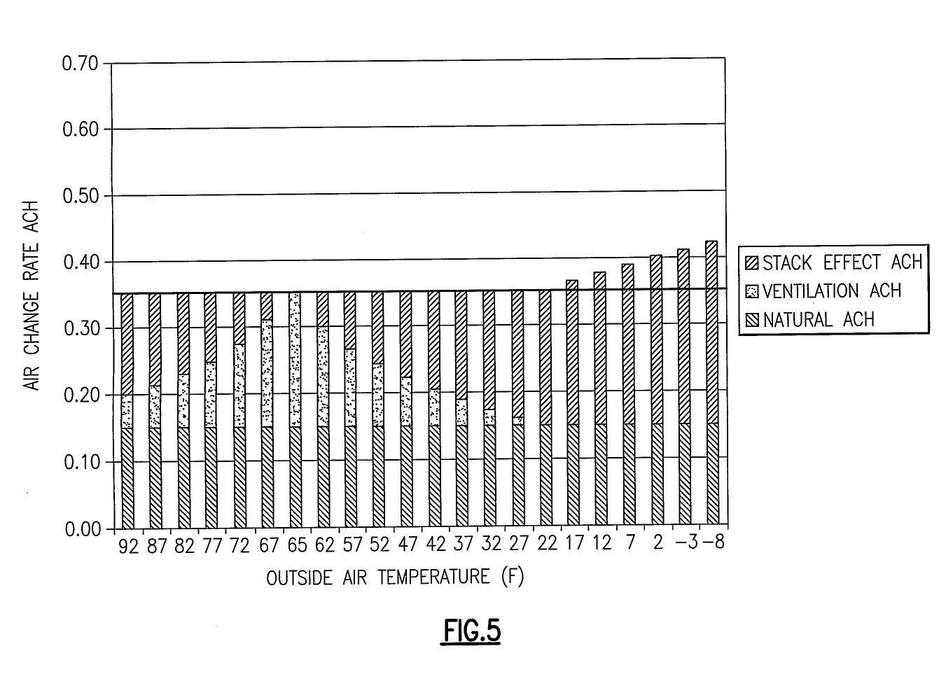

As will be seen in FIG. 5, when the stack effect ventilation has been calculated and the mechanical ventilation has, accordingly, been reduced, the total ventilation can be brought down to the desired level of 0.35 ACH, except for periods of extreme cold weather, as shown in FIG. 3, where the combined effect of stack effect and natural infiltration exceeds 0.35 ACH even with the mechanical system turned off.

Having described the concept, the method by which the outside ventilation airflow is controlled will now be described. As shown in FIG. 6, the position of the damper 12 is controlled by the control 11 operating a damper motor 21. The damper 12 is a simple open/shut damper that is either motor-driven or spring returned closed. The damper motor 21 is operated through the control 11 such that it is open whenever the furnace blower 22 is on. To prevent operation at excessively cold outside air temperatures, a normally closed temperature switch 23 is located in the damper assembly and opens if the temperature falls below a prescribed lower limit (e.g. 20° F.). This de-energizes the damper and closes it from the open position. The open position would be set in the field using a prescribed calibration technique to obtain the desired ventilation airflow (chart of pressure drop versus temperature versus cfm). An intermediate position may be provided with a separate motor winding for a cooling blower setting to compensate for higher cooling airflows. The amount of run time of the HVAC system blower is normal and that of the damper being opened, is varied to provide the required amount of outside air. One approach is to leave the damper in a fixed open position and vary the blower-on time to obtain the desired amount of ventilation. Other possible approaches include the varying of the blower motor speed or that at a dedicated fan motor such as in a heat recovery ventilator. The manner in which this is accomplished will now be described.

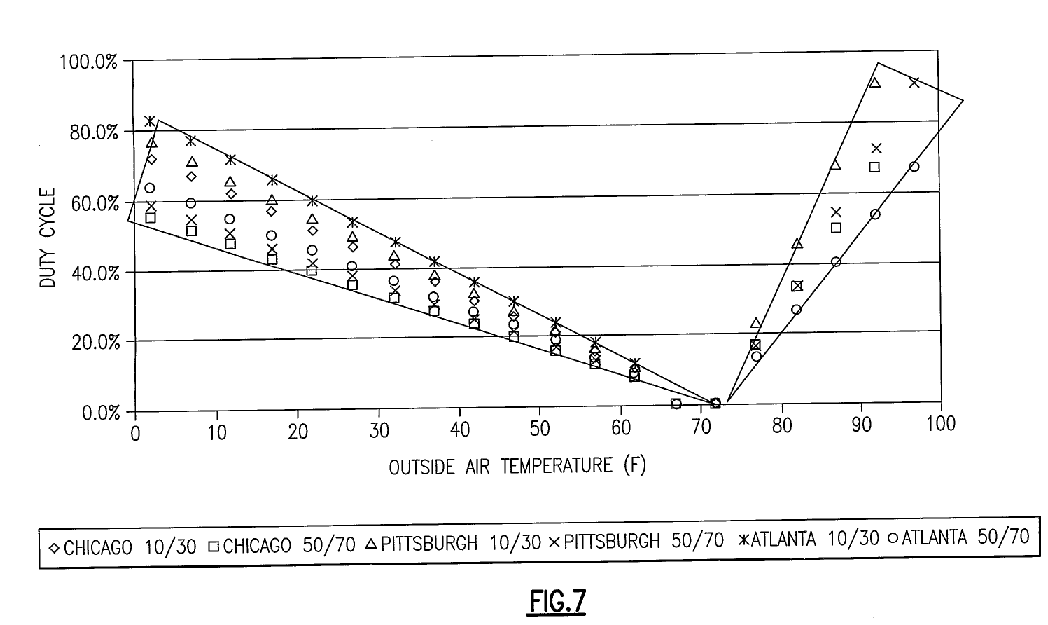

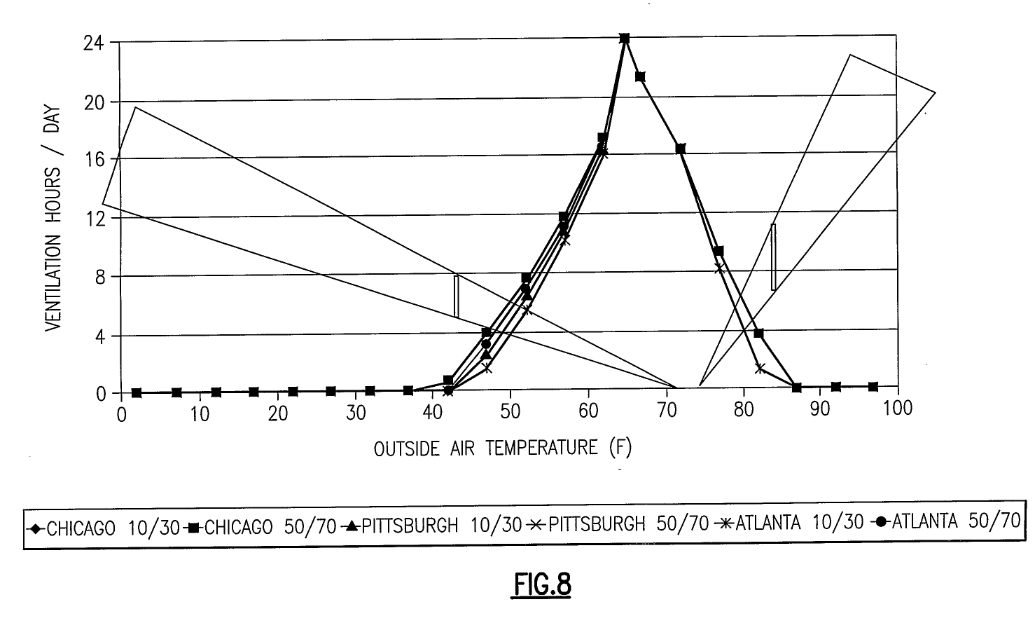

Shown in FIG. 7 is graphical representation of the on-time thermostatic duty cycle of a furnace (on the left) and for an air conditioner (on the right) over a range of outdoor air temperatures. At the bottom of the page, the first number (10 or 50) denotes the amount of oversizing in percent of the air conditioner to the cooling load, and where the second number (30 or 70) denotes the amount of oversizing of the furnace to the heating load). Since equipment over-sizing affects the outdoor air temperature vs. duty cycle relationship, a range of oversizing was analyzed for different geographic areas. For example, in Pittsburgh under a 50/70 condition when the outdoor air temperature is at about 22° F., the thermostat will cause the furnace to cycle on at about 60% of the time, while at outdoor air temperatures of 77° F., the air conditioner will cycle on at about 19% of the time. In normal operation mode, the furnace/air conditioner fan will be operating during these on times and will be turned off when the furnace or air conditioner is turned off.

Referring now to FIG. 8, there is shown a graphic illustration of the ventilation hours per day as a function of outdoor air temperature as necessary to meet the ASHRAE standards. For example, at about 65° F., where there is essentially no stack effect, the fan can be run 24 hours a day, but at temperatures below or above that level, the time in which the fan operates becomes progressively less. At about 50° F., for example, the fan will need to operate only around 4-6 hours per day. As will be seen in FIG. 7, this equates to about a 20% duty cycle.

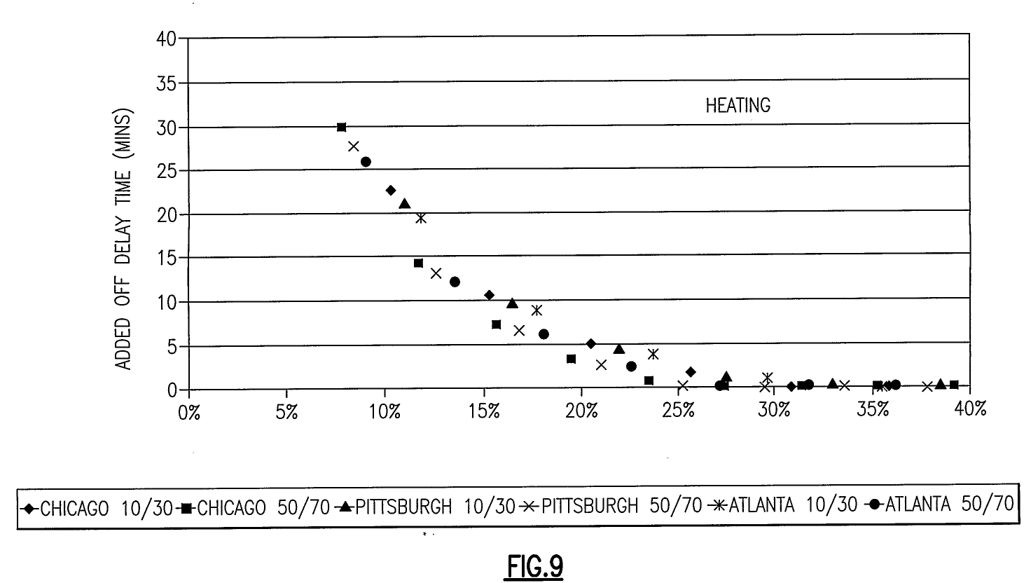

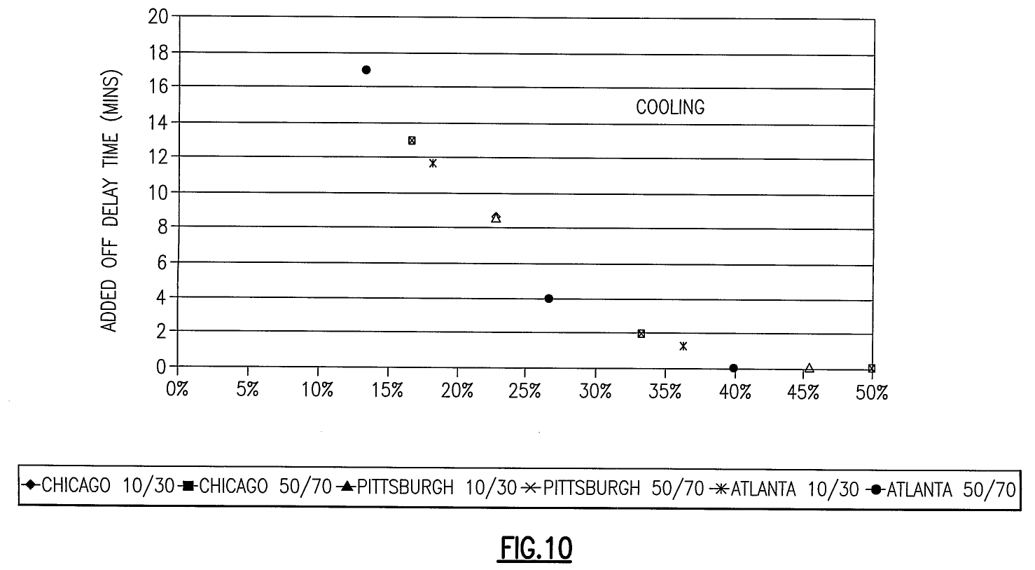

Referring now to FIG. 9, with the added fan off-delay-time as shown as a function of duty cycle, it will be seen that, in order for the outside air ventilation to be sufficient it may be necessary to run the fan for greater periods of time than for those of the heating duty cycle. In such cases the fan continues to run after the furnace cycle stops. Generally, as the duty cycle percentage decreases (i.e. as temperatures rise) time is added to the periods in which the fan continues to run after the cycle is complete. Thus, for the 50° F. example above, it will be seen that, at a 20% duty cycle, the added off delay time is about 5 minutes. Accordingly, whenever the furnace cycles to an off condition, the fan will be caused to operate for an additional 5 minutes and will then be shut off.

It should be recognized that the data points in the curves shown in FIGS. 8, 9, and 10 are fairly close together despite the wide range of oversizing and geographic locations. Thus it is believed that a single curve can be used to cover the majority of installations and locations.]

FIG. 10 shows the associated added off delay time as a function of percent duty cycle when operating in the cooling mode. For example, lowering the thermostat causes the air conditioner to operate at an on duty cycle of 27%, the fan will always condition to run for about another 4 minutes after the air conditioner has cycled to the off condition.

When the off delay time is determined to be zero as, for example, at about a 25% heating duty cycle or about a 40% cooling duty cycle, the damper will be moved to the closed position and remain there during periods in which the furnace or air conditioner is cycled on and off.

Another possible approach is to, rather than using the open and shut damper motor 21 as described in FIG. 6, using a stepper motor that can be modulated to maintain the required ventilation flow rate depending on the blower duty cycle. As the blower cycle rate changes with changing heat load and on/off cycle the damper would hold to maintain a constant volume of ventilation air every hour. If the blower is cycling less frequently, such as during mild weather, the damper would open. As it gets colder and the blower runs more, the damper would begin to gradually close. Sensing the cold ventilation air would either be direct, through an outside air temperature sensor, or indirectly, using an algorithm that is used on commercial available furnace. A low temperature limit switch could also be used as described hereinabove.

It should be understood that various other forms of the invention are possible. For example, although a default natural infiltration rate of 0.15 ACH and a desired ventilation rate of 0.35 ACH have been assumed, other rates may be more appropriate depending on the particular installation and its geographical location.

We claim:

1. A comfort system of the type having a heat exchanger coil and a fan for circulating air from a return air duct, through the coil and out to a supply air duct for a building structure, comprising:
an outside air duct for fluidly conducting the flow of outside air into the return air duct;
means for selectively varying the flow volume of outside air through said outside air duct and to said return air duct;
means for determining, as a function outdoor temperature condition, the change in the amount of natural infiltration of air into the structure that occurs as a result of leakage into the structure due to stack effect; and
controlling said flow varying means such that the sum of the natural infiltration of air and the flow of air in said outside air duct is substantially equal to a desired level.

2. A comfort system as set forth in claim 1 wherein said means for selectively varying the flow volume includes a damper.

3. A comfort system as set forth in claim 2 wherein said damper is an open/shut damper and is generally open when the fan is operating and closed when the fan is not operating.

4. A comfort system as set forth in claim 2 and including a fan that is cycled on when the comfort system is cycled by a thermostat and further including means for causing said fan to continue to operate for predetermined periods of time after the comfort system has cycled off.

5. A comfort system as set forth in claim 1 wherein said means for determining the amount of natural ventilation includes means for determining the pressure differential between the inside and outside of the structure.

6. A comfort system as set forth in claim 5 including means for determining the natural infiltration rate as a function of the pressure differential.

7. A comfort system as set forth in claim 3 wherein said damper is closed at outdoor temperatures below a predetermined level.

8. A method of controlling the flow volume of outside air to a return air duct of a comfort system for the purpose of maintaining an acceptable air quality in a structure, comprising the steps of:
establishing a desired level of total air change rate for the structure;
determining, as a function of outside air temperature, the amount of natural infiltration that occurs in the structure because of the stack effect; and
controlling the amount of outside air that flows to the return air duct such that the sum of the natural infiltration ventilation flow and the flow to the return air duct is maintained at a substantially predetermined uniform level.

9. A method as set forth in claim 8 wherein the step of controlling the flow of outdoor air includes the use of a fan and a damper, with the damper being generally open when the fan is operating and closed when the fan is not operating.

10. A method as set forth in claim 9 and including a fan that is cycled on when the comfort system is cycled on by a thermostat and including the step of selectively causing said fan to continue to operate for predetermined periods of time after the comfort system is cycled off.

11. A method as set forth in claim 8 wherein the step of determining the amount of natural ventilation that occurs includes the step of determining the pressure differential between the inside and outside of the structure.

12. A method as set forth in claim 11 and including the further step of determining the amount of natural ventilation that occurs as a function of the pressure differential.

13. A method as set forth in claim 9 and including the further step of closing said damper when the outside air reaches a predetermined lower level.

14. A method of controlling the flow of outside air to a structure having both natural ventilation that occurs from leakage into the structure and mechanical ventilation that is caused by mechanically inducing the flow of outside air into the structure comprising the steps of:
determining the amount of natural ventilation that occurs as a function of the outdoor air temperature; and
controlling the amount of mechanically induced flow of outside air into the structure such that the sum of the naturally occurring ventilation into the structure and that of the mechanically induced flow into the structure is substantially equal to a predetermined uniform level.

15. A method as set forth in claim 14 wherein the control of the mechanically induced flow is controlled by a fan and a damper, the damper being an open/shut damper which is generally open [or set to a limited open position] when the fan is operating and closed when the fan is not operating.

16. A method as set forth in claim 15 where the fan is associated with a comfort system and is cycled on by a thermostat and further wherein the fan is caused to continue to operate for predetermined periods of time after the comfort system has cycled off.

17. A method as set forth in claim 14 wherein the step of determining the amount of natural ventilation occurring includes the step of determining the differential pressure between the inside and outside of the structure.

18. A method as set forth in claim 17 and including the further step of determining the natural ventilation of air as a function of the pressure differential.

19. A method as forth in claim 15 and including the further step of closing the damper at outside temperatures below a predetermined level.
